(19) United States
(12) Patent Application Publication
(10) Pub. No.: US 2019/0036158 A1
(43) Pub. Date: Jan. 31, 2019

(54) BATTERY HAVING A SINGLE-ION CONDUCTING LAYER

(71) Applicant: Robert Bosch GmbH, Stuttgart (DE)

(72) Inventors: John F. Christensen, Elk Grove, CA (US); Sondra Hellstrom, East Palo Alto, CA (US); Nathan P. Craig, Burlingame, CA (US); Sun Ung Kim, Fremont, CA (US)

(21) Appl. No.: 16/039,522

(22) Filed: Jul. 19, 2018

Related U.S. Application Data
(60) Provisional application No. 62/538,154, filed on Jul. 28, 2017.

(51) Int. Cl. H01M 10/0562; H01M 10/0565; H01M 10/0585

(52) U.S. Cl. CPC H01M 10/0562; H01M 10/0565; H01M 2300/0085; H01M 2300/0071; H01M 10/0585

(57) ABSTRACT

An electrode configuration for a battery cell includes a positive electrode, a negative electrode, a separator interposed between the positive electrode and the negative electrode, and a first single-ion conducting layer deposited on one of the separator, the positive electrode, and the negative electrode. The first single-ion conducting layer is formed as a continuous thin-film layer.

### CLAIM OF PRIORITY

This application claims priority to U.S. Provisional Application Ser. No. 62/538,154 entitled “Battery Having a Single-Ion Conducting Layer” filed Jul. 28, 2017, the disclosure of which is incorporated herein by reference in its entirety.

### TECHNICAL FIELD

This disclosure relates generally to batteries, and more particularly to layer configurations for batteries.

### BACKGROUND

In batteries, ions transfer between the negative electrode and positive electrode during charge and discharge cycles. For instance, when discharging, electrons flow from the negative electrode, through an external circuit, to the positive electrode to generate an electrical current in the external circuit. During this process, positive ions, for example lithium ions in a lithium-ion battery, travel within the battery from the negative electrode, through an electrolyte, to the positive electrode. Conversely, when charging, the external circuit supplies current that reverses the flow of electrons from the positive electrode, through the external charging circuit, and back to the negative electrode, while the positive ions move within the battery from the positive electrode through the electrolyte to the negative electrode.

Two important measures by which the performance of batteries is determined are the energy density of the battery, or the ratio of the energy stored to the volume or mass of the battery, and the rate at which the battery can be charged or discharged. In conventional batteries, there is a tradeoff between the energy density of the battery and the rate at which the battery can be charged or discharged. For a given set of battery materials, the energy and charge/discharge rate can be modified by, for example, changing the quantity of active material in the electrodes. The amount of active material in the electrodes can be increased by either decreasing the pore space occupied by the electrolyte or by increasing the thickness of the electrode. Either of these modifications, however, leads to a decrease in the rate at which the cell can be charged or discharged.

A typical lithium-ion (“Li-ion”) battery has a negative electrode (“anode”), a positive electrode (“cathode”), and a porous polyolefin separator. An electrolyte is present in the separator and, in some batteries, the positive and negative electrodes, to provide a continuous ionic pathway for lithium ions to be transported between the two electrodes.

During charge or discharge of the battery, the movement of the lithium ions produces an electric field that typically also results in transport of the counter-ion, which can be for example PF₆⁻ in a battery in which the electrolyte includes LiPF₆. The counter-ion transport causes a salt concentration gradient through the cell that limits the rate of lithium ion transport by increasing the potential drop for a given current density as compared to a battery in which the counter-ions are immobile. This salt concentration gradient is known as “concentration polarization.”

During very high charge or discharge currents, the salt may be completely depleted at one of the electrodes. As a result, the available capacity at the high current on charge or discharge is limited, which thereby limits the charge or discharge rate of the battery. Furthermore, the depletion of the salt can, in some instances, result in deleterious parasitic reactions at one of the electrodes, for example lithium plating onto graphite on the negative electrode during fast charging.

Some conventional batteries attempt to reduce concentration polarization by increasing the mobility of the reactive ions in the battery. However, increasing the mobility of the reactive ions requires redesign of the electrolyte in the battery, which can involve a host of further considerations, can increase the cost of the battery, and can reduce the efficiency of the battery in other ways.

What is needed therefore is an alternative way of reducing the concentration polarization of a battery to improve the efficiency and performance of the battery.

### SUMMARY

In one embodiment, an electrode configuration for a battery cell includes a positive electrode, a negative electrode, a separator interposed between the positive electrode and the negative electrode, and a first single-ion conducting layer deposited on one of the separator, the positive electrode, and the negative electrode. The first single-ion conducting layer is formed as a continuous thin-film layer.

In some embodiments, the one of the separator, the positive electrode, and the negative electrode includes a gel electrolyte.

In a further embodiment, the first single-ion conducting layer includes lithium phosphorous oxy-nitride (“LiPON”). In some embodiments, the first single-ion conducting layer consists of only LiPON.

In another embodiment, the separator includes the gel electrolyte and the first single-ion conducting layer is deposited on the separator.

In some embodiments of the electrode configuration, the positive electrode includes the gel electrolyte, and the first single-ion conducting layer is deposited on the positive electrode.

In yet another embodiment, the negative electrode includes the gel electrolyte, and the first single-ion conducting layer is deposited on the negative electrode.

Some embodiments of the electrode configuration further include a second single-ion conducting layer deposited on a second one of the separator, the positive electrode, and the negative electrode. The second single-ion conducting layer formed as a continuous thin-film layer. The first single-ion conducting layer is interposed between the separator and the positive electrode, and the second single-ion conducting layer is interposed between the separator and the negative electrode.

In another embodiment of the electrode configuration, the separator includes the gel electrolyte. The first single-ion conducting layer is deposited on a first side of the separator and the second single-ion conducting layer is deposited on a second opposite side of the separator.

In yet another embodiment, the first single-ion conducting layer is deposited on the positive electrode and the second single-ion conducting layer is deposited on the negative electrode.

In a further embodiment, the first single-ion conducting layer is deposited on one of the positive electrode and the negative electrode, and the second single-ion conducting layer is deposited on the separator on an opposite side of the separator from the first single-ion conducting layer.

The separator, in some embodiments, is a continuous polymer layer. In one embodiment, the separator comprises at least one selected from the group consisting of polyethylene oxide (“PEO”), a polystyrene-ethylene oxide (“PS-EO”) copolymer, poly(methyl methacrylate) (“PMMA”), a vinylidene fluoride (“VDF”)/hexafluoropropylene (“HFP”) copolymer, and polyacrylonitrile.

In another embodiment of the electrode configuration, the first single-ion conducting layer has a thickness of between 10 nm and 1000 nm, and the separator has a thickness of between 5 μm and 20 μm.

In a further embodiment of the electrode configuration, the positive electrode and the negative electrode have at least one of: different salt compositions, different salt concentrations, different solvent compositions, and different additives.

In one embodiment, a battery comprises a plurality of battery cells, each battery cell including an electrode arrangement comprising a positive electrode, a negative electrode, a separator interposed between the positive electrode and the negative electrode, and a first single-ion conducting layer deposited on one of the separator, the positive electrode, and the negative electrode. The first single-ion conducting layer is formed as a continuous thin-film layer.

In a further embodiment, the one of the separator, the positive electrode, and the negative electrode includes a gel electrolyte.

In some embodiments of the battery, the first single-ion conducting layer includes lithium phosphorous oxy-nitride (“LiPON”).

In another embodiment, the separator includes the gel electrolyte and the first single-ion conducting layer is deposited on the separator.

The battery of another embodiment further comprises a second single-ion conducting layer deposited on a second one of the separator, the positive electrode, and the negative electrode. The second single-ion conducting layer is formed as a continuous thin-film layer. The first single-ion conducting layer is interposed between the separator and the positive electrode, and the second single-ion conducting layer is interposed between the separator and the negative electrode.

### BRIEF DESCRIPTION OF THE DRAWINGS

FIG. 1 is a schematic view of a battery pack according to the disclosure.

FIG. 2 is a schematic view of a battery electrode configuration of the battery pack of FIG. 1 having a SIC layer between the positive electrode and the separator.

FIG. 3 is a schematic view of a battery electrode configuration of the battery pack of FIG. 1 having a SIC layer between the negative electrode and the separator.

FIG. 4 is a schematic view of a battery electrode configuration of the battery pack of FIG. 1 having a first SIC layer between the positive electrode and the separator and a second SIC layer between the negative electrode and the separator.

### DETAILED DESCRIPTION

For the purposes of promoting an understanding of the principles of the embodiments described herein, reference is now made to the drawings and descriptions in the following written specification. No limitation to the scope of the subject matter is intended by the references. This disclosure also includes any alterations and modifications to the illustrated embodiments and includes further applications of the principles of the described embodiments as would normally occur to one skilled in the art to which this document pertains.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

The terms “comprising,” “including,” “having,” and the like, as used with respect to embodiments of the disclosure, are synonymous. As used herein, the term “approximately” refers to values that are within ±20% of the reference value.

The embodiments of the disclosure discussed below are applicable to any desired battery chemistry. Some examples refer to lithium-ion batteries for illustrative purposes. As used herein, the term “lithium-ion battery” refers to any battery which includes lithium as an active material. In particular, lithium-ion batteries include, without limitation, lithium based liquid electrolytes, solid electrolytes, gel electrolytes, and batteries commonly referred to as lithium-polymer batteries or lithium-ion-polymer batteries. As used herein, the term “gel electrolyte” refers to a polymer infused with a liquid electrolyte.

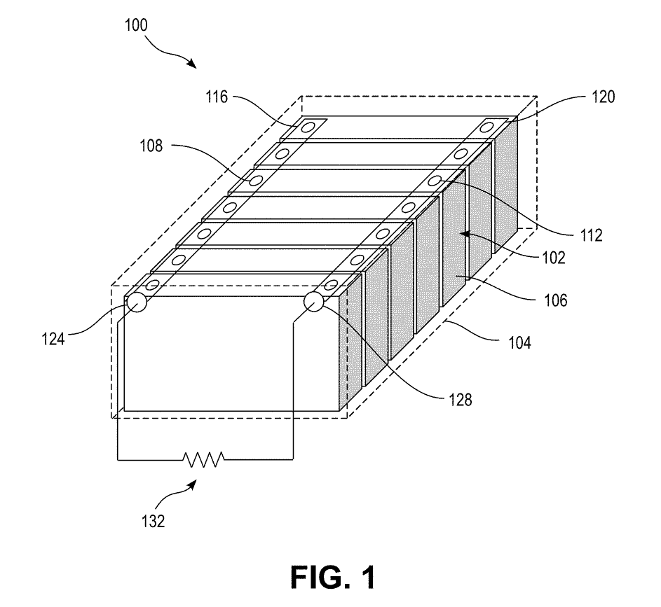

Referring now to FIG. 1, a battery pack 100 includes a plurality of battery cells 102 arranged in a pack housing 104. Each of the battery cells 102 includes a cell housing 106, from which a positive terminal 108 and a negative terminal 112 are exposed. In a parallel arrangement, the positive terminals 108 may be connected to one another by a bus bar 116, and the negative terminals 112 may be connected to one another by a different bus bar 120. In a series arrangement, the positive terminals 108 may be connected to adjacent negative terminals 112 by a current collector. The current collectors 116, 120 are connected to respective positive and negative battery pack terminals 124, 128, which connect to an external circuit 132 that may be powered by the battery pack 100, or may be configured to charge the battery pack 100.

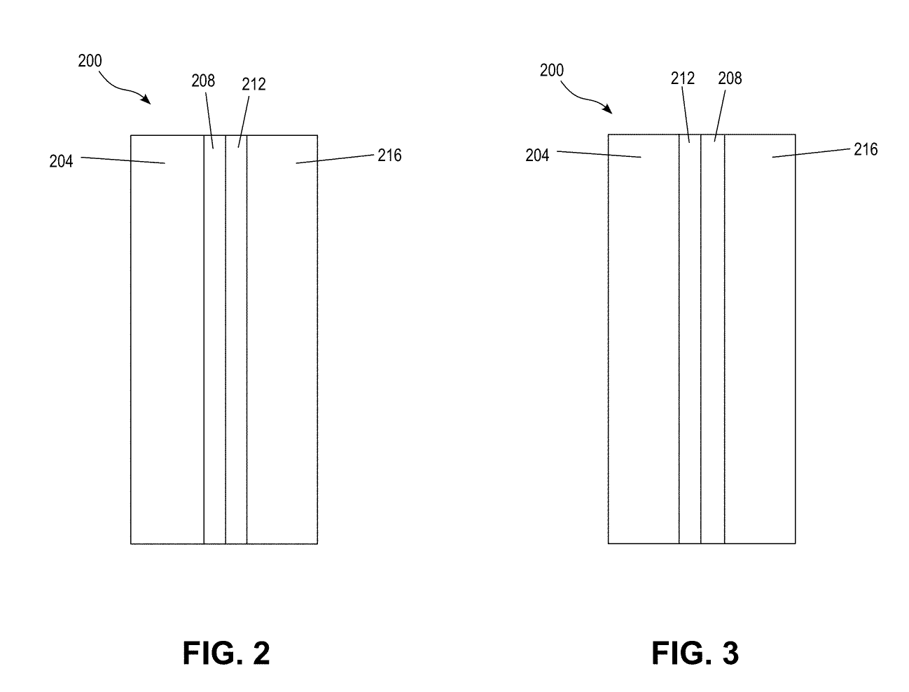

As depicted in FIG. 2, each battery cell 102 includes an electrode configuration 200, each of which includes a positive electrode 204, a single-ion conducting (“SIC”) layer 208, a separator layer 212, and a negative electrode 216. In some embodiments, multiple layers of the electrode configuration 200 are stacked on top of one another within the battery cell 102 so as to form an electrode stack. In other embodiments, the electrode configuration 200 is wound around itself in a spiral shape within the battery cell 102 so as to form what is known as a “jelly-roll” or “Swiss-roll” configuration.

The positive electrode has a thickness of between 1 and 500 microns and contains active material, electrically conductive additive material, and, in some embodiments, a polymeric binder material that binds the various materials together. In various embodiments, the active material may include one or more of lithium nickel-cobalt-aluminum oxide (“NCA”), lithium nickel-cobalt-manganese oxide (“NCM”), lithium cobalt oxide (“LCO”), lithium iron phosphate (“LFP”), lithium manganese oxide (“LMO”), a combination of these materials, or any other suitable positive electrode active material. The electrically conductive additive material may include one or more of carbon black, metal particles, and another suitable electrically conductive material. The binder material may be, for example, styrene-butadiene rubber (“SBR”) or polyvinylidene fluoride (“PVDF”). The positive electrode 204 is porous and includes a liquid or gel electrolyte within the pores, which, in some embodiments includes LiPF₆. In some embodiments of the positive electrode 204 that includes a gel electrolyte, the positive electrode 204 may not include the polymeric binder material.

The negative electrode 216 includes particles of active material, which can be, for example, graphite, hard carbon, silicon, silicon oxide, tin, lithium titanate (“LTO”), etc., or combinations of these materials. The negative electrode 216 may also include a polymeric binder, which can be, for example, SBR or PVDF, as well as a conductive additive, for example carbon black. Similar to the positive electrode 204, the negative electrode 216 is porous and includes a liquid or gel electrolyte within the pores, which, in some embodiments includes LiPF₆. In some embodiments of the negative electrode 216 that includes a gel electrolyte, the negative electrode 216 may omit the polymeric binder material.

The separator layer 212 is interposed between the positive and negative electrodes 204, 216 so as to separate the electrodes 204, 216. In some embodiments, the thickness of the separator layer 212 is less than 500 microns, and in further embodiments the thickness of the separator layer 212 is less than 20 microns. In embodiments of the battery 100, the separator layer 212 is formed of a porous polyolefin, which may be covered with coating of ceramic particles. The porous polyolefin of the separator 212 is filled with a liquid or gel electrolyte. In embodiments in which the electrolyte is a gel electrolyte, the separator 212 includes a continuous polymer layer, for example polyethylene oxide (“PEO”), a polystyrene-ethylene oxide (“PS-EO”) copolymer, poly(methyl methacrylate) (“PMMA”), a vinylidene fluoride (“VDF”)/hexafluoropropylene (“HFP”) copolymer, polyacrylonitrile (“PAN”), etc., or combinations thereof, infused with the liquid electrolyte. In some embodiments the separator may be a porous ceramic sheet that is filled with a liquid or gel electrolyte.

The SIC layer 208 is a relatively thin, continuous, single-ion conducting layer deposited on one or both of the electrodes 204, 216. In some embodiments, the SIC layer 208 is formed of lithium phosphorous oxy-nitride (“LiPON”), which has a low conductivity at room temperature (approximately 10⁻⁶ S/cm), but can be deposited as a thin film to reduce the ionic resistance of the SIC layer 208.

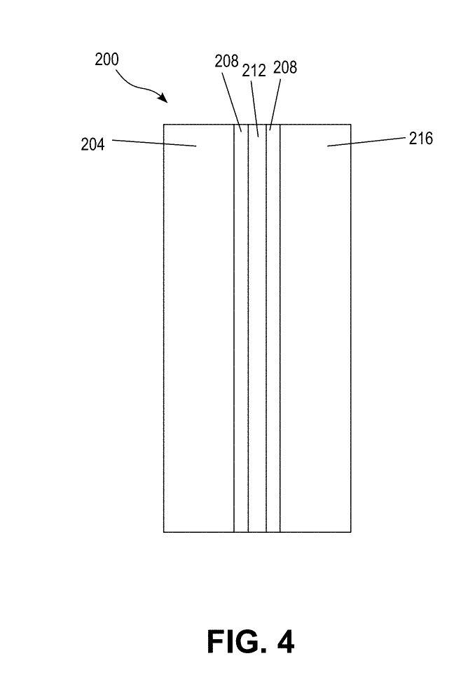

The SIC layer 208 is deposited on at least one of the positive electrode 204, the negative electrode 216, and the separator 212. In the embodiment illustrated in FIG. 2, the SIC layer 208 is deposited between the separator 212 and the positive electrode 204 on the separator 212, the positive electrode 204, or both the separator 212 and positive electrode 204. In another embodiment illustrated in FIG. 3, the SIC layer 208 is deposited between the separator 212 and the negative electrode 216 on the separator 212, the negative electrode 216, or both the separator 212 and the negative electrode 216. In yet another embodiment, illustrated in FIG. 4, the electrode configuration 200 includes two SIC layers 208, one interposed between the positive electrode 204 and the separator 212 and the other interposed between the separator 212 and the negative electrode 216.

In some embodiments, the layer on which the SIC layer 208 is deposited has a gel electrolyte. Thus, the LiPON is deposited on the polymer of the gel electrolyte instead of a porous substrate, which enables higher-quality LiPON thin-film deposition. In particular, applying the LiPON of the SIC layer 208 to a gel electrolyte layer enables the thin-film of the LiPON to cover the entire surface of the gel electrolyte, thereby forming a continuous unbroken layer that is interposed between the separator 212 and the associated electrode or electrodes. In some embodiments, the layer on which the SIC layer 208 is applied may include a portion that is formed of a gel electrolyte, and a portion that is formed of a porous solid with a liquid electrolyte. In such embodiments, the SIC layer is applied to the gel electrolyte portion.

The layers 204, 212, 216 on which the SIC layer 208 is not deposited may include a liquid electrolyte and/or a gel electrolyte. In one particular embodiment, the layer(s) on which the SIC layer 208 are not deposited have a liquid electrolyte, which results in improved ionic conductivity of the layer(s). In some embodiments that liquid and/or salt component of the gel electrolyte are introduced after the SIC is deposited onto the polymer component of the gel electrolyte and other solid components of the layer.

The SIC layer or layers 208 allow only single-ions, for example lithium ions, to travel across the layer boundary or boundaries. The SIC layer or layers 208 inhibit or prevent the salts from mixing across layers, thereby compartmentalizing the salt in each electrode 204, 216. As a result, counter-ion transport is reduced or eliminated, resulting in decreased salt polarization or concentration differences at high currents. Consequently, the charge and discharge rate capability of the battery cell is improved over a conventional battery.

In addition, since the SIC layer or layers 208 inhibits or prevents the salts from mixing across the SIC layers 208, the electrode configuration may have different salts or different salt compositions on opposing sides of the SIC layer or layers 208. As a result, the salt used in the positive electrode 204, the separator 212, and/or the negative electrode 216 may be different. This configuration enables optimizing the salts for the electrodes 204, 216 or the separator layer 212 based on the desired properties of the various layers 204, 212, 216. In some embodiments, the electrode configuration may have the same salt on opposing sides of the SIC layer(s) 208, but the concentrations of the salts, the compositions of the solvents used with the salts, or the additives used with the salts may be different on opposite sides of the SIC layer(s) 208.

In some conventional batteries, local salt depletion in the negative electrode can accelerate unwanted side reactions such as lithium metal deposition. In one embodiment according to the disclosure, the electrolyte in the negative electrode has a higher salt concentration, such that local depletion of the salt in the negative electrode is reduced or avoided during high rates of battery charging. For example, ultra-high salt concentrations have demonstrated high transference numbers (t+>0.7) compared to typical concentrations (t+˜0.4), which further reduces concentration polarization. However, higher salt concentrations can, at the same time, have higher ionic resistivity and therefore impart higher rates of internal heating under conditions of high charge and discharge current. Maintaining a lower salt concentration in the positive electrode (e.g., in the 1 to 1.4 M range, where conductivity is often highest) of the battery cell reduces or minimizes the resistance and rate of heating in the positive electrode. Moreover, increasing the salt concentration in the positive electrode is not as advantageous as increased salt concentration in the negative electrode, as lithium plating is less likely to occur in the positive electrode due to the high potential of the positive electrode. Moreover, salt tends to be an expensive component of the battery cell, and reducing the concentration of the salt where it is not necessary provides a cost advantage for the battery.

Furthermore, some solvents (e.g., acetonitrile, sulfones) have good stability at high potentials, at which the positive electrode operates, but may have reduced stability at low potential, at which the negative electrode operates. Therefore, compartmentalizing the positive and negative electrodes provides an opportunity to use different solvents, salts, and additives with different stability windows in the two electrodes, thereby improving the performance of the battery.

In one embodiment, the separator layer 212 includes a continuous polymer film of between approximately 5 μm and approximately 20 μm, and the separator layer 212 is coated with between approximately 10 nm and approximately 1000 nm of LiPON as the SIC layer 208. In one particular embodiment, the SIC layer 208 is between approximately 50 nm and approximately 500 nm of LiPON. The LiPON SIC layer 208 may be on the same side of the separator 212 as the positive electrode 204 (FIG. 2), the same side of the separator 212 as the negative electrode 216 (FIG. 3), or the separator 212 may be coated on both sides with SIC layers 208 (FIG. 4).

After formation of the electrode configuration 200, the negative electrode 216, separator 212, and positive electrode 204 are laminated together and stacked or wound together to form a high-capacity cell stack or jellyroll. This stack or jellyroll is placed in the cell housing 106 (FIG. 1), connected to the terminals 108, 112 via metal tabs by, for example, ultrasonic welding, and the liquid electrolyte is introduced into the housing to fill the pores of the electrodes 204, 216 (FIGS. 2-4) and, depending upon the configuration of the SIC layers, simultaneously gel the polymer in the separator 212. In some embodiments the SIC layers are deposited onto a layer (separator or electrode) containing already gelled electrolyte. In some embodiments, two or more compartments of the cell stack or jellyroll, as defined by the location of the SIC, must be filled with two or more collections of liquid electrolyte. Each of the liquid electrolytes may have a different composition, including different solvents, salts, and additives, and/or in different ratios.

The cell 102 is then sealed and undergoes formation cycles, and, in some embodiments, a post-formation degassing of the cell 102. In the disclosed embodiment, the amount of gel electrolyte is small compared to the amount of liquid electrolyte, or, put another way, the thickness over which the gel electrolyte has to transport ions is minimized. As a result, the ion conductivity of the battery, as a whole, is high compared to a battery that has a higher gel to liquid electrolyte ratio. In some embodiments, the separator 212 is formed from a block copolymer of VDF and HFP, or alternatively PS and EO, as a free-standing film with high mechanical strength, which facilitates deposition of the LiPON SIC layer 208 onto the separator 212.

In another embodiment, the LiPON, or another low-counter-ion-permeability layer, is coated onto one or both electrodes 204, 216, and the electrode(s) 204, 216 on which the LiPON is deposited contains a polymer that is subsequently gelled during the liquid electrolyte filling process. In this embodiment, the processing of the LiPON is facilitated.

In the battery 100 according to the disclosure, contrary to conventional batteries, the electrode configuration 200 includes the SIC layer 208 that has low permeability to counter-ions, which are the ions that do not participate in the electrode reactions. The lithium ions flow through the separator 212 and the SIC layer 208, from the negative electrode 216 to the positive electrode 204 during discharge of the battery. In a conventional battery, the counter-ions tend to flow in the opposite direction, from the positive electrode to the negative electrode during discharge. This causes the concentration of ions to be large near the negative electrode, and low near the positive electrode, which, as discussed above, can cause reduced charge and discharge capacity and speed of the battery, in addition to potentially undesirable reactions in the battery. The SIC layer 208 impedes the movement of the counter-ions from the positive electrode 204 to the negative electrode 216 during discharge of the battery 100. As a result, the concentration of the ions near the negative electrode and positive electrode remains closer to the equilibrium concentration. Accordingly, the negative concentration polarization effects are reduced in the battery 100. Likewise, during charging of the battery, the SIC layer 208 performs essentially the same function in reverse.

It will be appreciated that variants of the above-described and other features and functions, or alternatives thereof, may be desirably combined into many other different systems, applications or methods. Various presently unforeseen or unanticipated alternatives, modifications, variations or improvements may be subsequently made by those skilled in the art that are also intended to be encompassed by the foregoing disclosure.

1. An electrode configuration for a battery cell, comprising:
a positive electrode;
a negative electrode;
a separator interposed between the positive electrode and the negative electrode; and
a first single-ion conducting layer deposited on one of the separator, the positive electrode, and the negative electrode, the first single-ion conducting layer formed as a continuous thin-film layer.

2. The electrode configuration of claim 1, wherein the one of the separator, the positive electrode, and the negative electrode includes a gel electrolyte.

3. The electrode configuration of claim 2, wherein the first single-ion conducting layer includes lithium phosphorous oxy-nitride (“LiPON”).

4. The electrode configuration of claim 3, wherein the first single-ion conducting layer consists of LiPON.

5. The electrode configuration of claim 2, wherein the separator includes the gel electrolyte and the first single-ion conducting layer is deposited on the separator.

6. The electrode configuration of claim 2, wherein the positive electrode includes the gel electrolyte, and the first single-ion conducting layer is deposited on the positive electrode.

7. The electrode configuration of claim 2, wherein the negative electrode includes the gel electrolyte, and the first single-ion conducting layer is deposited on the negative electrode.

8. The electrode configuration of claim 2, further comprising:
a second single-ion conducting layer deposited on a second one of the separator, the positive electrode, and the negative electrode, the second single-ion conducting layer formed as a continuous thin-film layer,
wherein the first single-ion conducting layer is interposed between the separator and the positive electrode, and the second single-ion conducting layer is interposed between the separator and the negative electrode.

9. The electrode configuration of claim 8, wherein:
the separator includes the gel electrolyte; and
the first single-ion conducting layer is deposited on a first side of the separator and the second single-ion conducting layer is deposited on a second opposite side of the separator.

10. The electrode configuration of claim 8, wherein the first single-ion conducting layer is deposited on the positive electrode and the second single-ion conducting layer is deposited on the negative electrode.

11. The electrode configuration of claim 8, wherein the first single-ion conducting layer is deposited on one of the positive electrode and the negative electrode, and the second single-ion conducting layer is deposited on the separator on an opposite side of the separator from the first single-ion conducting layer.

12. The electrode configuration of claim 2, wherein the separator is a continuous polymer layer.

13. The electrode configuration of claim 12, wherein the separator comprises at least one selected from the group consisting of polyethylene oxide (“PEO”), a polystyrene-ethylene oxide (“PS-EO”) copolymer, poly(methyl methacrylate) (“PMMA”), a vinylidene fluoride (“VDF”)/hexafluoropropylene (“HFP”) copolymer, and polyacrylonitrile.

14. The electrode configuration of claim 2, wherein the first single-ion conducting layer has a thickness of between 10 nm and 1000 nm, and the separator has a thickness of between 5 μm and 20 μm.

15. The electrode configuration of claim 1, wherein the positive electrode and the negative electrode have at least one of: different salt compositions, different salt concentrations, different solvent compositions, and different additives.

16. A battery comprising:
a plurality of battery cells, each battery cell including an electrode arrangement comprising:
a positive electrode;
a negative electrode;
a separator interposed between the positive electrode and the negative electrode; and
a first single-ion conducting layer deposited on one of the separator, the positive electrode, and the negative electrode, the first single-ion conducting layer formed as a continuous thin-film layer.

17. The battery of claim 16, wherein the one of the separator, the positive electrode, and the negative electrode includes a gel electrolyte.

18. The battery of claim 17, wherein the first single-ion conducting layer includes lithium phosphorous oxy-nitride (“LiPON”).

19. The battery of claim 17, wherein the separator includes the gel electrolyte and the first single-ion conducting layer is deposited on the separator.

20. The battery of claim 17, further comprising:
a second single-ion conducting layer deposited on a second one of the separator, the positive electrode, and the negative electrode, the second single-ion conducting layer formed as a continuous thin-film layer,
wherein the first single-ion conducting layer is interposed between the separator and the positive electrode, and the second single-ion conducting layer is interposed between the separator and the negative electrode.
